(19) United States
(12) Patent Application Publication
(10) Pub. No.: US 2025/0085647 A1
(43) Pub. Date: Mar. 13, 2025

(54) POLYESTER RESIN EMULSION, RESIN PARTICLE, TONER, AND METHOD OF MANUFACTURING TONER

(71) Applicants: Masahiro Yukikawa, Kanagawa (JP); Junichi Watanabe, Kanagawa (JP); Akinori Saitoh, Kanagawa (JP); Yuka Mizoguchi, Kanagawa (JP)

(72) Inventors: Masahiro Yukikawa, Kanagawa (JP); Junichi Watanabe, Kanagawa (JP); Akinori Saitoh, Kanagawa (JP); Yuka Mizoguchi, Kanagawa (JP)

(73) Assignee: Ricoh Company, Ltd., Tokyo (JP)

(21) Appl. No.: 18/814,746

(22) Filed: Aug. 26, 2024

(30) Foreign Application Priority Data
Sep. 12, 2023 (JP) 2023-147781

(51) Int. Cl. G03G 9/093; C08G 63/672; C08J 3/12; G03G 9/08

(52) U.S. Cl. CPC G03G 9/09328; C08G 63/672; C08J 3/126; G03G 9/0804; G03G 9/09371; C08J 2367/00; C08J 2467/02

(57) ABSTRACT

A polyester resin emulsion contains resin particles (S) containing an amorphous polyester resin (A) in which the carboxyl group of a polyester resin obtained by polycondensation of the alcohol component and the carboxylic acid component is neutralized by a basic substance and an aqueous medium where the resin particles (S) are dispersed, wherein the following relationship 1 is satisfied:

$$0.89 \leq B / A \leq 2.23 ,$$

where A represents an acid value of the amorphous polyester resin (A) and B represents an amount in mmol/g of cation derived from the basic substance.

### CROSS-REFERENCE TO RELATED APPLICATIONS

This patent application is based on and claims priority pursuant to 35 U.S.C. § 119 to Japanese Patent Application No. 2023-147781, filed on Sep. 12, 2023, in the Japan Patent Office, the entire disclosure of which is hereby incorporated by reference herein.

### BACKGROUND

### Technical Field

The present invention is related to a polyester resin emulsion, a resin particle, a toner, and a method of manufacturing a toner.

### Description of the Related Art

In the field of image forming apparatuses using electro-photographic methods, there has been an increasing demand in the market for toner with superior low-temperature fixability due to the emphasis on energy conservation. At the same time, ongoing efforts aim to develop toner that does not exhibit blocking, which is the fusion of toner particles under severe high-temperature and high-humidity conditions. Additionally, as image forming apparatuses have achieved higher performance, there is a need for toner that can withstand the stress applied within the developing machine.

Amidst this trend, in recent years, toners with a core-shell structure have been developed, featuring a shell layer on the toner surface that provides excellent heat resistance and mechanical durability.

### SUMMARY

According to embodiments of the present disclosure, a polyester resin emulsion is provided containing resin particles (S) containing an amorphous polyester resin (A) in which the carboxyl group of a polyester resin obtained by polycondensation of the alcohol component and the carboxylic acid component is neutralized by a basic substance and an aqueous medium where the resin particles (S) are dispersed, wherein the following relationship 1 is satisfied:

$$0.89 \leq B / A \leq 2.23 ,$$

where A represents an acid value of the amorphous polyester resin (A) and B represents an amount in mmol/g of cation derived from the basic substance.

As another aspect of embodiments of the present disclosure, a resin particle is provided, containing a resin particle (T) with a core-shell structure comprising a shell layer formed from the polyester resin emulsion mentioned above.

As another aspect of embodiments of the present disclosure, a toner is provided, containing a core particle and a shell layer on a surface of the core particle, wherein the shell layer is formed of the polyester resin emulsion of claim 1.

As another aspect of embodiments of the present disclosure, a method of manufacturing a toner with a core-shell structure is provided, including forming a shell layer from the polyester resin emulsion mentioned above and forming the shell layer on a core particle.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present invention, a polyester resin emulsion for toner is provided, which allows for the formation of a core-shell structure of the toner, wherein shell particles are uniformly and defect-freely arranged on the surface of the core particles to form a shell layer. This shell layer exhibits excellent adhesion with the core particles, preventing peeling even under developing stress within an image forming apparatus.

Various technologies have been proposed and implemented for achieving the core-shell structure of toners. Among these, chemical toners using polyester resin with superior low-temperature fixing properties for both core particles and shell particles are now mainstream. For example, emulsion aggregation toners with a core-shell structure, which exhibit excellent low-temperature fixability and mechanical durability, have been proposed in Japanese Unexamined Patent Application Publications Nos. 2013-235244 and 2010-066651.

In such technologies, it is extremely important to arrange the shell particles uniformly, without defects, on the surface of the core particles to form the shell layer, ensuring low-temperature fixability, heat resistance during storage, and mechanical durability. If the shell particles are not formed properly, the shell layer may peel off from the core particles due to the developing stress within the image forming apparatus, significantly degrading the toner performance.

On the other hand, a method of incorporating polyethylene terephthalate (PET) into the resin of the core and shell parts has been proposed in Japanese Patent No. 6632066. In this method, polyethylene terephthalate is introduced into the shell part, which reduces the surface exposure of wax in an attempt to improve the durability of the toner. Furthermore, using recycled polyethylene terephthalate contributes to reducing the environmental burden, such as reducing the use of petroleum resources. However, introduction of polyethylene terephthalate into the shell particles that form the shell part lowers the hydrophobicity of the shell particles, leading to a decrease in cohesion between the core particles and the shell particles, making it difficult to form a uniform shell layer.

### Polyester Resin Emulsion for Toner

In the polyester resin emulsion for toner of the present invention, a resin particle (S) containing an amorphous polyester resin (A) is dispersed in an aqueous medium. The polyester resin (S) may optionally contain other resins along with the amorphous polyester resin (A). In addition, the aqueous medium may contain other substances such as a surfactant and polymer protective colloid. Hereinafter, the amorphous polyester resin (A) is also referred to as the polyester resin (A).

The method of manufacturing the emulsion is not particularly limited and known methods can be employed.

One method is shear emulsification, where the polyester resin (A) is dissolved in an organic solvent and then dispersed with a homomixer or homogenizer using a mechanical shearing force such as low-speed shear, high-speed shear, friction, high-pressure jet, or ultrasonic method, or with a media-containing ball mill, sand mill, or Dyno mill.

Another method is phase inversion emulsification, where the polyester resin (A) is dissolved in an organic solvent, followed by the addition of an aqueous medium for phase inversion. In particular, the phase inversion emulsification method is preferred due to its ability to produce a homogeneous emulsion with a sharp particle size distribution.

In the present invention, the particle size of the resin particle (S) in the emulsion is not particularly limited, but preferably, the median diameter (D50) is between 0.05 μm and 0.8 μm, more preferably between 0.1 μm and 0.5 μm, and particularly preferably between 0.15 μm and 0.3 μm. If the median diameter (D50) is less than 0.05 μm, the aggregation efficiency of the shell particles on the core particles decreases, which can easily lead to problems such as insufficient shell layer thickness on the toner surface. On the other hand, if the median diameter (D50) is greater than 0.8 μm, the shell particles are less likely to aggregate uniformly on the surface of the core particles, making the shell layer thickness more likely to be uneven. The median diameter (D50) in the present invention is measured using a laser diffraction particle size distribution analyzer LA-920 (available from HORIBA, Ltd.).

In the present invention, the solid content concentration of the emulsion is not particularly limited. It is preferably between 5 percent by mass and 50 percent by mass, more preferably between 30 percent by mass and 45 percent by mass. A solid content concentration of less than 5 percent by mass lowers the aggregation efficiency of the shell particles on the core particles, which decreases the productivity of the toner. A solid content concentration of more than 50 mass percent may increase a risk of reducing the dispersion stability of the emulsion.

The solid content concentration in the present invention is calculated by weighing an emulsion sample in an aluminum cup, drying it in a thermostatic chamber set at 150 degrees Celsius for 3 hours, and then weighing the sample again.

### Phase Inversion Emulsification

In the present invention, the phase inversion emulsification method includes dissolving the polyester resin (A) in an organic solvent to obtain a resin solution, and then adding an aqueous medium to this resin solution for phase inversion emulsification. Additionally, other resins can be dissolved and used together with the polyester resin (A) as long as it does not impair the effects of the invention. Furthermore, a neutralizing agent, surfactant, or polymer protective colloid may be optionally added to the resin solution or the aqueous medium.

The emulsion containing the resin solution obtained by both the aforementioned phase inversion emulsification and an aqueous medium preferably has the organic solvent removed promptly to stabilize the dispersion. There are no particular limitations on the method for removing the organic solvent, and a known desolvation method can be appropriately selected according to the purpose.

Specific examples of the methods include, but are not limited to, a method of gradually heating the emulsion during stirring to evaporate and remove the organic solvent in the system, a method of spraying the emulsion into a dry atmosphere such as air or nitrogen during stirring to remove the organic solvent in the system, and a method of reducing the pressure during stirring the emulsion to evaporate and remove the organic solvent in the system. These methods can be used alone or in combination.

### Amorphous Polyester Resin (A)

The polyester resin (A) of the present invention is a polyester resin obtained by polycondensation of an alcohol component and a carboxylic acid component.

The alcohol component preferably contains at least one trivalent or tetravalent alcohol with a linear or branched saturated aliphatic structure having 4 to 6 carbon atoms. By introducing a trivalent or tetravalent alcohol with a linear or branched saturated aliphatic backbone having 4 to 6 carbon atoms into the resin, the hydroxyl value (OHV) of the resin can be controlled, and the cohesiveness and adhesion of the emulsion to the core particles can be improved.

In the present invention, the term “linear” refers to a structure in which there are no carbon-carbon bonds other than the carbon chain (hereinafter referred to as the “main chain”) connected by the minimum number of carbon atoms between two oxygen elements randomly selected from the oxygen elements derived from the hydroxyl groups in the monomer units of the alcohol component. On the other hand, the term “branched” refers to a structure that has carbon-carbon bonds in addition to the main chain.

Specific examples of trivalent aliphatic alcohols with 4 to 6 carbon atoms include, but are not limited to, 1,2,3-butanetriol, 1,2,4-butanetriol, trimethylolethane, 1,2,3-pentanetriol, 1,2,4-pentanetriol, 1,2,5-pentanetriol, 1,3,5-pentanetriol, 2,3,4-pentanetriol, trimethylolpropane, 1,2,3-hexanetriol, 1,2,6-hexanetriol, 1,3,5-hexanetriol, and 2-isopropylpropane-1,2,3-triol.

Specific examples of tetravalent aliphatic alcohols with 4 to 6 carbon atoms include, but are not limited to, pentaerythritol, 1,2,3,4-butanetetraol, 1,2,3,4-pentanetetraol, 1,2,3,5-pentanetetraol, 1,2,4,5-pentanetetraol, 1,2,4,5-hexanetetraol, and 1,2,5,6-hexanetetraol.

These trivalent or tetravalent aliphatic alcohol can be used alone or in combination.

The content of the trivalent or tetravalent alcohols with a linear or branched saturated aliphatic structure having 4 to 6 carbon atoms is not particularly limited. It is preferably 0.5 to mole percent relative to the alcohol component in the resin, and more preferably 2 to 5 mole percent. If the content is less than 0.5 mole percent, sufficient cohesiveness to the core particles may not be obtained, leading to an increase in non-shelled particles. If the content exceeds 10 mole percent, the branched chains in the resin become too numerous, resulting in a lower melting viscosity of the shell portion in the toner, which makes it difficult to achieve sufficient heat resistance during storage-storage stability in high temperature environments- and hot offset resistance.

In addition to the trivalent or tetravalent alcohols with a linear or branched saturated aliphatic structure having 4 to 6 carbon atoms, other known alcohols can also be used as the alcohol component.

These other alcohols are not particularly limited.

Specific examples include, but are not limited to, aliphatic diols such as ethylene glycol, 1,2-propanediol, 1,3-propanediol, 1,4-butanediol, 2,3-butanediol, 3-methyl-1,5-pentanediol, 1,6-hexanediol, neopentyl glycol, 2-ethyl-1,3-hexanediol, 1,8-octanediol, 1,10-decanediol, 1,12-dodecanediol; diols with oxyalkylene groups such as diethylene glycol, triethylene glycol, dipropylene glycol, polyethylene glycol, polypropylene glycol, polytetramethylene glycol; alicyclic diols such as 1,4-cyclohexanedimethanol, 1,4-sorbitan, hydrogenated bisphenol A; adducts of alkylene oxides such as ethylene oxide, propylene oxide, or butylene oxide with the alicyclic diols; bisphenols such as bisphenol A, bisphenol F, bisphenol S; adducts of alkylene oxides such as alkylene oxides such as ethylene oxide, propylene oxide, or butylene oxide with the bisphenols; tri- or higher alicyclic alcohols such as heptanetriol, octanetriol, decanetriol, sorbitol, dipentaerythritol; polyphenols such as trisphenol, phenol novolak, cresol novolak; adducts of alkylene oxide such as ethylene oxide, propylene oxide, and butylene oxide with the polyphenols. These other alcohols can be used alone or in combination.

Among these other alcohols, it is particularly preferable to use 1,2-propanediol, 1,3-propanediol, 1,4-butanediol, and 2,3-butanediol.

Using these diols as the alcohol component of the resin allows for the formation of a shell layer with an excellent balance of low-temperature fixability and mechanical durability. Additionally, it is preferable for these diols to be biomass-derived, as this can reduce carbon dioxide emissions when the resulting toner is eventually incinerated.

The content of the aforementioned 1,2-propanediol, 1,3-propanediol, 1,4-butanediol, and 2,3-butanediol is not particularly restricted, but it is preferably not less than 30 mole percent relative to the alcohol components in the resin. More preferably, it is not less than 50 mole percent, and particularly preferably, it is not less than 80 mole percent. If it is less than 30 mole percent, it becomes difficult to achieve low-temperature fixability and mechanical durability, and the effect of reducing environmental impact is also small.

Specific examples of the carboxylic acid component include, but are not limited to, aliphatic dicarboxylic acids or their anhydrides such as oxalic acid, adipic acid, succinic acid, azelaic acid, dodecanedioic acid, maleic acid, citraconic acid, itaconic acid, alkene succinic acid, and fumaric acid; polyfunctional aliphatic carboxylic acids or their anhydrides with three or more carboxyl groups such as 1,2,4-butanetricarboxylic acid, 1,2,5-hexanetricarboxylic acid, 1,3-dicarboxy-2-methyl-2-methylenepropane, tetra(methylenecarboxy)methane, 1,2,7,8-octanetetracarboxylic acid; aromatic dicarboxylic acids such as phthalic acid, isophthalic acid, terephthalic acid, naphthalenedicarboxylic acid; polyfunctional aromatic carboxylic acids with three or more carboxyl groups such as trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, and their anhydrides and partial lower alkyl esters. These carboxylic acid components can be used alone or in combination.

The polyester resin (A) in the present invention may contain repeating units derived from so-called polyethylene terephthalate (PET), which is a condensate of terephthalic acid and ethylene glycol. It can be obtained by polycondensation with raw material monomers during an ester exchange reaction.

The polyester resin containing repeating units derived from PET is excellent in mechanical durability, making it suitable as a resin for the shell layer in toner. Furthermore, it is particularly preferable to use so-called recycled PET, which is recovered through recycling as a raw material, as it contributes to reducing environmental impact, such as lowering the consumption of petroleum resources.

On the other hand, introducing PET into the shell particles decreases the hydrophobicity of the shell particles and also reduces the cohesiveness between the core particles and the shell particles, making it difficult to form a uniform shell layer. However, the emulsion in the present invention does not compromise the cohesiveness or adhesion with the core particles, even when polyester resin with such introduced PET is used.

The content of the repeating units derived from PET is not particularly restricted, but it is preferably between 10 percent by mass and 70 percent by mass relative to the components in the resin, and more preferably between 30 percent by mass and 60 percent by mass. If it is less than 10 percent by mass, the polyester resin's mechanical durability effect may be difficult to achieve, and if it is more than 70 percent by mass, the polyester resin will not dissolve easily in organic solvents, and low-temperature fixability will also deteriorate.

The polycondensation of the alcohol component and the carboxylic acid component can be carried out, for example, at a temperature of 180 degrees Celsius to 250 degrees C. Celsius in an inert gas atmosphere in the presence of the aforementioned esterification catalyst.

The esterification catalyst is not particularly limited. Examples include, but are not limited to, titanium compounds and tin(II) compounds that do not have an Sn—C bond. These can be used either alone or in combination.

Among these, titanium compounds with Ti—O bonds are preferred, and compounds with alkoxyl, alkenyl oxy, or acyl oxy groups totaling 1 to 28 carbon atoms are even more preferred.

Specific examples include, but are not limited to, titanium isopropylate bis-triethanolamine, titanium isopropylate bis-diethanolamine, titanium pentylate bis-triethanolamine, titanium dietholate bis-triethanolamine, titanium hydroxyoctylate bis-triethanolamine, titanium stearate bis-triethanolamine, titanium triisopropylate triethanolamine, titanium monopropylate tris(triethanolamine), tetra-n-butyl titanate, tetrapropyl titanate, tetra-stearyl titanate, tetra-milistyl titanate, tetra-octyl titanate, dioctyl dihydroxyoctyl titanate, and dimilistyl dioctyl titanate.

The amount of titanium compounds is preferably from 0.01 to 1.0 parts by mass relative to 100 parts by mass of the total amount of the alcohol component and the carboxylic acid component, with 0.1 to 0.5 parts by mass being more preferable.

As tin(II) compounds that do not have an Sn—C bond, tin(II) compounds with an Sn—O bond or tin(II) compounds with an Sn—X bond (where X represents a halogen atom) are preferred, with tin(II) compounds having an Sn—O bond being more preferred.

Specific examples of tin (II) compounds having Sn—O bonds include, but are not limited to, carboxylic acid tin (II) compounds with carbon numbers ranging from 2 to 28, such as stannous oxalate, stannous acetate, stannous octanoate, stannous 2-ethylhexanoate, stannous laurate, stannous stearate, and stannous oleate; alkoxyl tin (II) compounds with carbon numbers ranging from 2 to 28, such as octyloxyl tin (II), lauryloxyl tin (II), stearyloxyl tin (II), and oleyloxyl tin (II); tin oxide (II); and tin sulfate (II).

Specific examples of the tin (II) compounds having Sn—X bonds include halogenated tin (II) compounds such as tin (II) chloride and tin (II) bromide.

The amount of the tin(II) compounds is preferably from 0.01 to 1.0 parts by mass, and more preferably from 0.1 to 0.5 parts by mass, based on the total amount of 100 parts by mass of the alcohol component and the carboxylic acid component.

In the case that both titanium compound and tin(II) compound are used, the total amount of these compounds is preferably from 0.01 to 1.0 parts by mass relative to 100 parts by mass of the total amount of the alcohol component and the carboxylic acid component, with 0.1 to 0.5 parts by mass being more preferable.

The acid value (AV) is not particularly limited, but it is preferably between 15 mg KOH/g and 30 mg KOH/g, and more preferably between 18 mg KOH/g and 25 mg KOH/g. An acid value (AV) of less than 15 mg KOH/g is likely to make emulsification difficult and degrade the stability of the emulsion. An acid value of more than 30 mg KOH/g causes the charge stability of the toner against environmental changes to deteriorate.

The glass transition temperature of the polyester resin (A), which is obtained from the second heating DSC curve measured by differential scanning calorimetry (DSC), is not particularly limited. It is preferably between 60 degrees Celsius and 75 degrees Celsius. If the glass transition temperature is lower than 60 degrees C., the heat resistance of the toner deteriorates. If the glass transition temperature exceeds 75 degrees Celsius, the low-temperature fixability tends to deteriorate.

The glass transition temperature can be measured using a differential scanning calorimeter (DSC) (e.g., Q-200 by TA Instruments).

The weight average molecular weight (Mw) of the polyester resin (A) measured by gel permeation chromatography (GPC) is not particularly limited. It is preferably from 0.8×10⁴ to 1×10⁵, and more preferably from 1×10⁴ to 5×10⁴. If the Mw is less than 0.8×10⁴, the polyester resin tends to exhibit better low-temperature fixability but lower mechanical durability. If the Mw is greater than 1×10⁵, low-temperature fixability tends to deteriorate.

The Mw can be measured using a GPC device (e.g., HLC-8220GPC by Tosoh Corporation).

### Other Resins

The emulsion of the present invention can be dissolved and used together with the polyester resin (A) as long as it does not impair the effects of the invention.

There is no specific limit to the other resin and any known resin can be suitably selected to a particular application.

Specific examples include, but are not limited to, styrene polymers and substituted styrene polymers such as polystyrene, poly-p-styrene, and polyvinyltoluene; styrene copolymers such as styrene-p-chlorostyrene copolymers, styrene-propylene copolymers, styrene-vinyltoluene copolymers, styrene-methyl acrylate copolymers, styrene-ethyl acrylate copolymers, styrene-methacrylate copolymers, styrene-methyl methacrylate copolymers, styrene-ethyl methacrylate copolymers, styrene-butyl methacrylate copolymers, styrene-α-methyl chloromethacrylate copolymers, styrene-acrylonitrile copolymers, styrene-vinyl methyl ether copolymers, styrene-vinyl methyl ketone copolymers, styrene-butadiene copolymers, styrene-isopropyl copolymers, and styrene-maleic acid ester copolymers; and other resins such as polymethyl methacrylate, polybutyl methacrylate, polyvinyl chloride, polyvinyl acetate, polyethylene, polyesters, epoxy resins, polyurethane resins, polyvinyl butyral resins, polyacrylic resins, rosin, modified rosins, terpene resins, phenol resins, aliphatic or aromatic hydrocarbon resins, aromatic petroleum resins, and the resins specified above which are modified to have a functional group reactive with an active hydrogen group such as an isocyanate group. These can be used alone or in combination.

### Organic Solvent

The organic solvent used in the phase inversion emulsification method in the present invention can be chosen appropriately according to the purpose. For example, ethanol, isopropanol, isobutanol, acetone, methyl ethyl ketone, methyl isobutyl ketone, diethyl ketone, dibutyl ether, tetrahydrofuran, dioxane, methyl acetate, ethyl acetate, isopropyl acetate, toluene, xylene, benzene, carbon tetrachloride, methylene chloride, 1,2-dichloroethane, 1,1,2-trichloroethane, trichloroethylene, chloroform, monochlorobenzene, and dichloroethylene, can be listed. These can be used alone or in combination. Among these, methyl ethyl ketone, ethyl acetate, and isopropyl acetate are particularly preferable to remove the solvent and dissolve the polyester resin.

### Aqueous Medium

The aqueous medium used in the phase inversion emulsification method in the present invention is not particularly restricted and can be appropriately selected depending on the purpose. For example, water or mixtures of water with organic solvents miscible with water can be used.

The amount of the aqueous medium to be added is not particularly limited, but it is preferably 80 to 150 parts by mass per 100 parts by mass of the resin solution.

In the phase inversion emulsification method in the present invention, there are no specific restrictions on the rate of addition of the aqueous medium from the beginning of phase inversion of the resin solution until its completion. Preferably, the rate of addition is 0.1 to 60 parts by mass per minute per 100 parts by mass of the resin solution, and more preferably 1 to 3 parts by mass per minute. If the rate is less than 0.1 parts by mass/min, the productivity of the toner decreases. If the rate exceeds 60 parts by mass/min, the particle size distribution becomes broad, leading to variations in the aggregation of shell particles on core particles and causing the shell layer to become uneven.

### Neutralizer

In the phase inversion emulsification method of the present invention, a neutralizer is added to either the resin solution or the aqueous medium.

Examples of the neutralizer include basic substances. Specific examples include, but are not limited to, ammonia, trimethylamine, ethylamine, diethylamine, triethylamine, diethanolamine, triethanolamine, tributylamine, lithium hydroxide, sodium hydroxide, and potassium hydroxide. Among these, ammonia and sodium hydroxide are preferably used.

### Surfactant

In the phase inversion emulsification method of the present invention, a surfactant can be optionally added to either the resin solution or the aqueous medium.

The choice of surfactant is not particularly restricted and can be appropriately selected depending on the purpose.

Specific examples include, but are not limited to, anionic surfactants such as alkylbenzene sulfonates, alpha-olefin sulfonates, and phosphate esters; amine salt types such as alkylamine salts, aminoalcohol fatty acid derivatives, polyamine fatty acid derivatives, and imidazolines; cationic surfactants such as alkyltrimethylammonium salts, dialkyldimethylammonium salts, alkylbenzyldimethylammonium salts, pyridinium salts, alkylisoquinolinium salts, and benzethonium chloride; nonionic surfactants such as fatty acid amide derivatives and polyhydric alcohol derivatives; and amphoteric surfactants such as alanine, dodecyl dimethyl glycine, di(octylaminoethyl) glycine, and N-alkyl-N,N-dimethylammonium betaines.

### Polymer Protection Colloid

In the phase inversion emulsification method of the present invention, a polymer protection colloid can be optionally added to either the resin solution or the aqueous medium.

The polymer protection colloids are not particularly limited and can be suitably selected to suit to a particular application.

Specific examples include, but are not limited to, polymers and copolymers prepared using monomers, for example, acids (e.g., acrylic acid, methacrylic acid, α-cyanoacrylic acid, α-cyanomethacrylic acid, itaconic acid, crotonic acid, fumaric acid, maleic acid, and maleic anhydride), (meth)acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycolmonoacrylic acid esters, diethylene glycolmonomethacrylic acid esters, glycerinmonoacrylic acid esters, N-methylolacrylamide and N-methylolmethacrylamide); vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide, and diacetoneacrylamide) and their methylol compounds, acid chlorides (e.g., acrylic acid chloride and methacrylic acid chloride); monomers having a nitrogen atom or a heterocyclic ring having a nitrogen atom (e.g., vinyl pyridine, vinyl pyrrolidone, vinyl imidazole, and ethylene imine); polyoxyethylene compounds (e.g., polyoxyethylene, polyoxypropylene, polyoxy ethylene alkyl amines, polyoxypropylene alkyl amines, polyoxy ethylenealkyl amides, polyoxypropylene alkyl amides, polyoxyethylene nonylphenyl ethers, polyoxyethylene lauryl phenyl ethers, polyoxyethylene stearylphenyl esters, and polyoxyethylene nonylphenyl esters), and cellulose compounds, for example, methyl cellulose, hydroxyethyl cellulose, and hydroxy propyl cellulose.

### Resin Particle (T) and Toner

In the present invention, the resin particles (T) and the toner have a core-shell structure with shell particles aggregated and fused onto core particles using the polyester resin emulsion of the present invention. After the formation of this core-shell structure, the resin particles (T) and the toner may undergo additional processes such as washing, drying, and annealing. Additionally, additives may be optionally applied to the surface of the resin particles (T) and the toner.

The volume average particle diameters (Dv) of the resin particles (T) and the toner are not particularly limited and they can be suitably selected to suit to a particular application. They are preferably from 3 to 10 μm, with 4 to 7 μm being more preferable, to produce high-quality images with excellent particle size distribution, sharpness, and fine line reproduction. If Dv is less than 3 μm, the image sharpness and fine line reproduction are excellent, but the toner may exhibit reduced flowability and transferability. The ratio (Dv/Dn) of Dv to the number average molecular weight (Dn) indicates the particle size distribution of the toner, with a value closer to 1 indicating a sharper distribution. For sharpness and fine line reproduction, a Dv/Dn of 1.20 or less is preferred, and 1.15 or less is more preferable.

Dv and Dn can be measured using a Coulter Multisizer III (aperture diameter 100 μm) (available from Beckman Coulter Inc.).

The average circularity of the resin particles (T) and the toner is preferably between 0.940 and 0.990, with a more preferable range being 0.960 to 0.985 while the particles with a circularity less than 0.94 accounts for 15 or less percent. Toner with circularity within the above range, i.e., substantially spherical toner, is effective in achieving excellent transfer efficiency, forming high-resolution images with moderate density and fine reproducibility.

Moreover, fine line images with less transfer voids can be obtained.

This is because the sufficiently smooth toner surface reduces contact points with the image bearer and decreases the occurrence of poor transfer to the transfer material. If the toner circularity is lower than this range and the shape deviates too much from spherical, transferability tends to be reduced. Conversely, if the circularity is higher and closer to spherical, transferability is excellent. However, systems employing blade cleaning may experience cleaning failures on the image bearer and transfer belt, resulting in foul images. For instance, in low image area ratio development or transfer, transfer residual toner is minimal and cleaning issues are less problematic. However, in high image area ratio cases such as color photo images, or when there are issues like paper feeding failures, untransferred toner used for image formation may remain on the image bearer as transfer residual toner, accumulating thereon and causing background fouling. In addition, the toner may contaminate the charging roller for charging an image bearer in a contact manner, thereby degrading the original charging power of the roller.

The average circularity can be measured using, for example, a flow type particle image analyzer FPIA-3000 available from SYSMEX CORPORATION.

Specifically, the average circularity of each particle is calculated from the two-dimensional image area of each particle captured by a charge coupled diode (CCD) camera, summing the circularity values of all particles, and dividing the sum by the total number of particles. The circularity of each particle can be calculated by dividing the perimeter of a circle with the same projected area as the particle image by the perimeter of the particle's projected image.

### Core-Shell Structure

In the present invention, the core-shell structure refers to a configuration where a shell layer made of resin is formed on the outermost surface of the core particles, covering the surface of the core particles. Such a core-shell structure allows the toner to exhibit excellent homogeneity, storage stability in high temperature environments, and mechanical durability, and enhances resistance to shell peeling caused by stress.

The resin particles (T) and the toner with the core-shell structure are obtained by adding shell particles to a liquid dispersion of core particles in an aqueous medium, agglomerating the shell resin on the surface of the core particles during stirring, and then fusing the core and shell particles by heating. The shell particles are composed of the polyester resin emulsion of the resin particles (S) of the present invention.

### Shell Layer

The shell layer is obtained by using a polyester resin emulsion composed of the resin particles (S) of the present invention as the shell particles, agglomerating the shell particles on the outermost surface of the core particles to form the shell layer, and then heating to fuse them.

It is preferable for the core particles and the shell layer to be in close contact with each other, but it is also preferred that they do not completely dissolve into each other, leaving a distinct region composed solely of the shell layer.

In the core-shell structure, the surface of the core particles does not have to be completely covered by the shell layer, but it is preferable for the coverage ratio to be high to enhance toner homogeneity, storage stability in high temperature environment, and mechanical durability.

The average thickness of the shell layer is not particularly limited, but a thickness of 50 nm to 500 nm is preferable, and a thickness of 100 nm to 200 nm is more preferable. If the average thickness is less than 50 nm, the protective function of the shell layer for the core particles lowers, leading to deterioration in storage stability in high temperature environments and mechanical durability. If the average thickness exceeds 500 nm, the level of low-temperature fixability may be reduced.

The average thickness of the shell layer can be confirmed by embedding toner particles in epoxy resin, slicing the embedded sample with a microtome or ultramicrotome to create ultrathin sections, and observing these ultrathin sections using a transmission electron microscope (TEM). In some cases, staining the ultrathin sections with staining agents such as ruthenium tetroxide or osmium tetroxide can make the core-shell structure more visible. In the present invention, the sample with toner particles embedded in epoxy resin is ultrathin-sectioned using an ultramicrotome, and the cross-sectional image is captured at a factor of 20,000 using a TEM (Field Emission Electron Microscope JEM-2100F available from JEOL Ltd.). The captured image is then processed using an image analysis device (Luzex AP available from Nireco Corporation), and the shell layer thickness of 30 toner particles is measured at five points each, with the average value being calculated from these measurements.

### Aggregation

In the aggregation method of aggregating shell particles on the surface of core particles, the resin emulsion forming the shell particles (hereinafter referred to as “shell resin emulsion”) is first dispersed in the dispersion of core particles, followed by stirring to apply collision energy or heating to apply thermal energy. Optional steps include adding aggregation agents such as inorganic metal salts or adjusting the pH.

The shell resin emulsion not only affects the emulsion stability and the aggregation with core particles but also influences the adhesion to the core particles in heating and fusing the shell particles to form a shell layer.

In the present invention, the present inventors have found that the shell particles are uniformly and efficiently aggregated and aligned and form layers without peeling off during thermal fusion when the following Equation (1) is satisfied:

$$0.89 ≦ B / A ≦ 2.23 \qquad Equation ( 1 )$$

where A (mmol/g) denotes the acid value (AV) of the amorphous polyester resin (A) and B (mmol/g) denotes the amount of cations derived from the basic substance of a carboxyl group that is neutralized by the basic substance of the amorphous polyester resin (A).

The value of B is determined by the following equation when the acid value of the amorphous polyester resin (A) is A [mgKOH/g].

B (mmol/g)=A (mgKOH/g)/molecular weight of KOH (56.11)×degree of neutralization (percent)

If the ratio (B/A) is less than 0.89, the emulsion stability is low, and homoaggregation of the shell resins occurs before aggregation with the core particles, making it impossible to form a uniform shell layer on the surface of the core particles. Conversely, if the ratio (B/A) exceeds 2.23, the cations derived from the basic substance accelerate aggregation, causing the same phenomenon. As a result, the shell layer obtained has defects, the number of shell particles not aggregated with the core particles increases, and these remain as fine particles in the toner, reducing the toner quality. Additionally, the adhesion to the core particles decreases during heating and fusing the shell particles to form the shell layer, making the shell layer prone to peeling and preventing the shell layer from fully functioning.

The temperature of the aqueous medium during the aggregation is not particularly limited, but for efficient aggregation, it is preferable to maintain the temperature between 20 degrees Celsius and around the glass transition temperature (Tg) of the polyester resin (A).

The aggregating agent is not particularly limited.

Specific examples include, but are not limited to, aluminum chloride, zinc sulfate, magnesium sulfate, aluminum sulfate, potassium aluminum sulfate, sodium chloride, sodium bromide, sodium iodide, sodium fluoride, sodium acetate, sodium acetate, lithium chloride, lithium bromide, lithium iodide, lithium fluoride, lithium acetate, lithium acetate, potassium chloride, potassium bromide, potassium iodide, potassium fluoride, potassium acetate, magnesium bromide, magnesium chloride, magnesium iodide, magnesium fluoride, magnesium acetate, magnesium acetate, calcium chloride, calcium bromide, barium bromide, barium chloride, barium iodide, barium fluoride, barium acetate, barium acetate, strontium bromide, strontium chloride, strontium iodide, strontium fluoride, strontium acetate, strontium acetate, zinc bromide, zinc chloride, zinc iodide, zinc fluoride, zinc acetate, zinc acetate, copper bromide, copper chloride, copper iodide, copper fluoride, copper acetate, copper acetate, iron bromide, iron chloride, iron iodide, iron fluoride, iron acetate, and iron acetate. These can be used alone or in combination.

The proportion of the aggregation agent is not particularly limited. The number of parts of the aggregation agent is preferably from 0.1 to 20 parts by mass and more preferably from 0.5 to 10 parts by mass to 100 parts by mass of the total of the core particles and the shell particles. Additionally, using the aggregation agent as an aqueous solution is preferred to achieve uniform aggregation within the reaction system. The concentration of the aqueous solution is preferably between 1 percent by mass and 50 percent by mass, with 5 percent by mass to 20 percent by mass being more preferable.

The rate of adding the aggregates to the aqueous medium is not particularly limited, but a rate of 0.1 parts by mass per minute to 5 parts by mass per minute relative to 100 parts by mass of the aqueous medium is preferable, with 0.5 parts by mass per minute to 2 parts by mass per minute being more preferable.

This aggregation can be halted as necessary. Methods for ceasing the aggregation include:
Adding low-valency salts, chelating agents, or surfactants.
Adjusting the pH.
Lowering the temperature of the liquid dispersion.
Diluting the dispersion by adding a large amount of aqueous medium.

Specific examples of the chelating agents include, but are not limited to, metal salts such as ethylenediaminetetraacetic acid sodium salt, sodium gluconate, sodium tartrate, sodium citrate, potassium citrate, and nitrotriacetate salts, as well as polymeric electrolytes.

### Fusion

The fusion process involves heating the aggregated particles composed of core particles and shell particles obtained from the aggregation to fuse them and form the shell layer. It is preferable to heat the liquid dispersion of the aggregated particles during stirring.

There is no particular restriction on the temperature in the fusion process. Preferably, the temperature is at least the glass transition temperature (Tg) of the polyester resin (A).

### Core Particle

The core particles are not particularly restricted. Examples include, but are not limited to, particles produced by methods such as kneading and grinding or by chemical processes that involve granulating particles in an aqueous medium. In the case of core particles obtained through the kneading pulverization method mentioned earlier, it is preferable to use core particles that have undergone sphericalization treatment and surface smoothing treatment by, for example, heating to form a uniform shell layer.

The core particles are preferably in the form of an aqueous dispersion for aggregation with the polyester resin emulsion of the present invention. Therefore, the core particles are preferably in the form of an aqueous dispersion obtained through a chemical process of granulating in an aqueous medium. Additionally, the core particles are preferably not treated with additives or flowability improvers for the purpose of aggregating shell particles onto the surface of the core particles in the present invention.

Specific examples of the chemical methods for granulating toner particles in an aqueous medium include, but are not limited to: suspension polymerization methods, emulsion polymerization methods, seed polymerization methods, and dispersion polymerization methods using a monomer as the starting material; dissolution suspension methods, where a resin or resin precursor is dissolved in an organic solvent and then dispersed and/or emulsified in an aqueous medium; phase inversion emulsification methods, where water is added to a solution containing a resin or resin precursor and a suitable emulsifier to induce phase inversion; and aggregation methods, where particles obtained by these methods are dispersed in an aqueous medium and then aggregated and granulated by processes such as heating and melting to achieve the desired particle size. Among these methods, dissolution suspension methods, phase inversion emulsification methods, and aggregation methods using particles obtained by these methods are preferred for their ease of handling and for producing polyester resins with excellent low-temperature fixability.

As long as the core particles meet the conditions of the present invention, any material can be used. They may optionally contain materials such as binder resins, crystalline resins as fixing agents, colorants, release agents, and charge control agents.

There is no specific limitation to the binder resin and any known resin can be suitably selected to a particular application.

Specific examples include, but are not limited to, styrene polymers and substituted styrene polymers such as polystyrene, poly-p-styrene, and polyvinyltoluene; styrene copolymers such as styrene-p-chlorostyrene copolymers, styrene-propylene copolymers, styrene-vinyltoluene copolymers, styrene-methyl acrylate copolymers, styrene-ethyl acrylate copolymers, styrene-methacrylate copolymers, styrene-methyl methacrylate copolymers, styrene-ethyl methacrylate copolymers, styrene-butyl methacrylate copolymers, styrene-α-methyl chloromethacrylate copolymers, styrene-acrylonitrile copolymers, styrene-vinyl methyl ether copolymers, styrene-vinyl methyl ketone copolymers, styrene-butadiene copolymers, styrene-isopropyl copolymers, and styrene-maleic acid ester copolymers; and other resins such as polymethyl methacrylate, polybutyl methacrylate, polyvinyl chloride, polyvinyl acetate, polyethylene, polyesters, epoxy resins, polyurethane resins, polyvinyl butyral resins, polyacrylic resins, rosin, modified rosins, terpene resins, phenol resins, aliphatic or aromatic hydrocarbon resins, aromatic petroleum resins, and the resins specified above which are modified to have a functional group reactive with an active hydrogen group such as an isocyanate group. These can be used alone or in combination.

Among these, it is particularly preferable to use at least one type of amorphous polyester resin (B), as it enhances the adhesion to the shell particles in the present invention, allowing for the production of toner with excellent stress resistance. Additionally, there are no particular limitations on the amorphous polyester resin (B), and the same types as used for polyester resin (A) can also be employed.

The crystalline resin is preferably melted near the fixing temperature. Including this crystalline resin in the toner ensures that it melts at the fixing temperature and becomes compatible with the binder resin, thereby enhancing the toner's sharp melting and providing excellent low-temperature fixing capability.

The crystalline resin is not particularly limited as long as it has crystallinity and can be suitably selected to suit to a particular application. The crystalline resin includes, for example, polyester resin, polyurethane resin, polyurea resin, polyamide resin, polyether resin, vinyl resin, and modified crystalline resin. These can be used alone or in combination. Among these, polyester resin (hereinafter referred to as crystalline polyester resin (C) is preferred.

There are no specific restrictions on the melting point of the crystalline resin. It is preferably between 60 degrees Celsius and 100 degrees Celsius. If the melting point is below 60 degrees Celsius, the crystalline resin is likely to begin to melt at low temperatures, which can reduce the storage stability of the toner in high temperature environments. If it exceeds 100 degrees Celsius, the effect on low-temperature fixability is less pronounced.

The colorant has no particular limitation.

Specific examples include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. These can be used alone or in combination.

There are no particular limitations on the content of the colorant in the resin particles (T) or the toner, but it is preferably between 1 percent by mass and 15 percent by mass, and more preferably between 3 percent by mass and 10 percent by mass. If the content is less than 1 percent by mass, the coloring power of the toner is likely to decrease. If it exceeds 15 percent by mass, the pigment is poorly dispersed in the toner, which may lead to a decrease in coloring power and a deterioration in the electrical properties of the toner.

The colorant and the resin can be used in combination as a master batch. There is no specific limitation on the resin.

Specific examples include, but are not limited to, polymers of styrene or substituted styrene, styrene-based copolymers, polymethyl methacrylate resins, polybutyl methacrylate resins, polyvinyl chloride resins, polyvinyl acetate resins, polyethylene resins, polypropylene resins, polyesters resins, epoxy resins, epoxy polyol resins, polyurethane resins, polyamide resins, polyvinyl butyral resins, polyacrylic resins, rosin, modified rosins, terpene resins, aliphatic hydrocarbon resins, alicyclic hydrocarbon resins, aromatic petroleum resins, chlorinated paraffin, and paraffin. These can be used alone or in combination.

The release agent is not particularly limited.

Specific examples include, but are not limited to, carnauba wax, rice wax, montan wax, trimethylolpropane tribehenate, pentaerythrityl tetrabehenate, pentaerythrityl diacetate dibehenates, glyceryl tribehenate, stearyl icosenoate, behenyl eicosylate, behenyl behenate, stearyl behenate, phenyl behenate, and stearyl stearate, among alkanic acid esters; polyalcohol esters such as trimellitic acid tristearate, and distearyl maleate; polyalkanoic acid amides such as dibehenylamide; polyalkyl amides such as trimellitic acid and tristearlyl amide; dialkyl ketones such as distearyl ketone; polyolefin waxes such as polyethylene wax, and polypropylene wax; and wax types such as paraffin wax, microcrystalline wax, and Sazol wax, which are long-chain hydrocarbons. These can be used alone or in combination. Among these, alkanic acid ester waxes are preferred.

There are no particular limitations on the melting point of the release agent, but it is preferably between 40 degrees Celsius and 160 degrees Celsius, more preferably between 50 degrees Celsius and 120 degrees Celsius, and particularly preferably between 60 degrees Celsius and 90 degrees Celsius. If the melting point is below 40 degrees Celsius, it may adversely affect storage stability in high temperature environments, and if it exceeds 160 degrees Celsius, cold offset can easily occur during low-temperature fixing.

There are no particular limitations on the content of the release agent in the resin particles (T) or the toner, but it is preferably between 1 percent by mass and 20 percent by mass, more preferably between 3 percent by mass and 15 percent by mass, and particularly preferably between 3 percent by mass and 7 percent by mass. A proportion exceeding 20 percent by mass may degrade flowability of the toner.

There is no specific limitation to the selection of the charge control agent. Specific examples include, but are not limited to, nigrosine dyes, triphenylmethane dyes, chrome containing metal complexes, chelate compounds of molybdic acid, Rhodamine dyes, alkoxyamines, quaternary ammonium salts, alkylamides, phosphor and compounds including phosphor, tungsten and compounds including tungsten, fluorine-containing activators, metal salts of salicylic acid and metal salts of salicylic acid derivatives.

The proportion of the charge control agent is not particularly limited. The number of parts of the charge control agent is preferably from 0.1 to 10 parts by mass and more preferably from 0.2 to 5 parts by mass to 100 parts of the resin particles (T) or the toner. If it exceeds 10 parts by mass, the chargeability of the toner may be excessively enhanced, leading to reduced flowability of the developer and decreased image density.

### Washing, Drying, Annealing

The resin particles (T) and toner of the present invention may undergo optional processes such as washing, drying, and annealing.

As for the washing methods, there are no particular limitations. Examples include centrifugal separation, vacuum filtration, and filter press methods. Any of these methods can yield a cake of resin particles (T) and toner. If the washing is not sufficient in a single operation, the cake obtained can be redispersed in an aqueous solvent to form a slurry, and the toner particles can be retrieved by repeating any of the aforementioned methods. Furthermore, in the case of vacuum filtration or filter press methods, it is also acceptable to conduct washing by allowing the aqueous solvent to penetrate the cake.

The aqueous solvents used for washing include, for example, water or mixed solvents of water and alcohols such as methanol or ethanol. Among these, water is preferred considering cost and environmental impact such as wastewater treatment.

The cake obtained from washing contains a large amount of aqueous medium, so it is preferable to dry the cake.

There are no particular restrictions on the drying method. Examples include, but are not limited to, spray dryers, vacuum freeze dryers, vacuum dryers, static shelf dryers, mobile shelf dryers, fluidized bed dryers, rotary dryers, agitated dryers, and other drying machines. It is preferable for the drying to continue until the moisture content is less than one percent. Furthermore, the resin particles (T) and toner obtained after drying may be pulverized using devices such as jet mills, Henschel mixers, super mixers, coffee mills, Oster blenders, or food processors to break up aggregates.

Annealing is particularly preferably conducted for the core particles containing crystalline polyester resin (C).

It is preferable that the annealing temperature be set between the glass transition temperature and the melting point of the crystalline polyester resin (C). Additionally, the annealing time is preferably conducted for 3 to 24 hours, with a more preferable duration being 6 to 15 hours.”

### External Additive

Examples of the external additives include, but are not limited to, inorganic fine particles, polymer fine particles, flowability enhancers, and cleaning improvers.

### Inorganic Fine Particle

Specific examples of such inorganic fine particles include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

The inorganic particulate preferably has a primary particle diameter of from 5 nm to 2 μm, and more preferably from 5 nm to 500 nm. In addition, the specific surface area of such inorganic particulates measured by a BET method is preferably between 20 m²/g to 500 m²/g.

The content of the inorganic fine particles is preferably from 0.01 to 5 percent by mass to the total amount of the toner.

### Polymer Fine Particle

The polymer fine particles include, but are not limited to, polystyrene, methacrylates, and acrylates obtained by soap-free emulsion polymerization, suspension polymerization, or dispersion polymerization, and polycondensed particles such as silicone, benzoguanamine, and nylon, and polymer particles of thermocuring resin.

### Flowability Enhancer

There is no particular limitation to the flowability enhancer mentioned above as long as it is surface-treated for enhancing hydrophobicity and can keep the fluidity and chargeability even in a highly humid environment.

Specific examples include, but are not limited to, silane coupling agents, silylating agents, silane coupling agents including an alkyl fluoride group, organic titanate coupling agents, aluminum-containing coupling agents, silicone oil, and modified silicone oil.

Hydrophobic silica and hydrophobic titanium oxide, which are formed by surface-treating the silica and the titanium oxide mentioned above with such flowability improvers are particularly preferably used.

### Cleaning Improver

The cleaning improver is not particular limited as long as it can be added to the toner to remove the developing agent remaining on the image bearer (photoconductor) or a primary intermediate transfer element after image transfer.

Specific examples include, but are not limited to, metal salts of fatty acid including stearic acid, zinc stearate, calcium stearate, and polymer fine particles such as polymethyl methacrylate fine particles and polystyrene fine particles, which are prepared by a soap-free emulsion polymerization method.

The polymer fine particles preferably have a relatively sharp particle size distribution and its volume average particle diameter is preferably between 0.01 μm and 1 μm.

Mixing with External Additive

The external additive aforementioned is attached to the particle surface by mixing with the resin particles (T) and the toner.

There are no particular restrictions on the methods of mixing mentioned above. For example, methods include applying impact force to the mixture by blades rotating at high speed, and introducing the mixture into a high-speed airflow to collide particles or composite particles with a suitable collision plate in an accelerated manner.

Specific examples of such mixing devices include, but are not limited to, ONG MILL (available from Hosokawa Micron Co., Ltd.), modified I TYPE MILL (available from Nippon Pneumatic Mfg. Co., Ltd.) in which the pressure of pulverization air is reduced, HYBRIDIZATION SYSTEM (manufactured by Nara Machine Co., Ltd.), KRYPTRON SYSTEM (available from Kawasaki Heavy Industries, Ltd.), and automatic mortars.

### Developing Agent

The developing agent relating to the present invention contains at least the toner and other suitably selected optional components such as carrier.

The developing agent can be a one-component developing agent and a two-component developing agent and the two-component developing agent is preferable in terms of the length of the working life particularly when used in a high speed printer that meets the demand for high speed information processing of late.

When a one-component developing agent using the toner described above is used and replenished, i.e., the supply of toner to the developer and the consumption of toner due to development, the variation in the particle diameter of the toner is small, no filming of the toner on the developing roller occurs, and no fusion bonding of the toner onto members such as a blade for regulating the thickness of the toner layer occurs. Consequently, good and stable development performance and image quality can be achieved even during long-term use (stirring) of the developing device.

In a case of a two-component developing agent using the toner described above, extended toner replenishment over time does not significantly alter the particle size of the toner in the developing agent, which leads to excellent and stable development performance during long-term agitation in the developing device.

There is no specific limitation to the carrier and it can be suitably selected to suit to a particular application. It is preferable to use a carrier particle that has a core material and a resin layer covering the core material.

There is no specific limitation to the material for the core material and it can be suitably selected among known materials. For example, manganese-strontium (Mn—Sr) based material and manganese-magnesium (Mn—Mg) based material having 50 to 90 emu/g are preferable. To ensure the image density, highly magnetized materials such as powdered iron having at least 100 emu/g and magnetite having 75 to 120 emu/g are preferable. In addition, weakly magnetized copper-zinc (Cu—Zn) based materials having 30 emu/g to 80 emu/g are preferable to reduce the impact of the contact between the toner filaments formed on the development roller and the latent electrostatic image bearer, which is advantageous in improvement of the image quality. These can be used alone or in combination.

The core material preferably has an average particle diameter (weight average particle diameter D50) of from 10 to 200 μm and more preferably from 40 to 100 μm. When the weight average particle diameter D50 is too small, fine powder tends to increase in the distribution of the carrier particles and the magnetization per particle tends to decrease, which leads to scattering of the carrier particles. When the weight average particle diameter D50 is too large, the specific surface area tends to decrease, resulting in scattering of toner. In a full color image in which solid portions occupy a large ratio, reproducibility tends to deteriorate particularly in the solid portions.

There is no specific limitation to the selection of the material for the resin layer mentioned above and any known resin can be suitably selected to suit to a particular application.

Specific examples include, but are not limited to, amino-based resins, polyvinyl-based resins, polystyrene-based resins, polycarbonate-based resins, polyethylene resins, polyvinyl fluoride resins, polyvinylidene fluoride resins, polytrifluoroethylene resins, polyhexafluoropropylene resins, copolymers of vinylidene fluoride and acrylate monomer, copolymers of vinylidene fluoride and vinyl fluoride, fluoroterpolymers such as terpolymers of tetrafluoroethylene, fluorovinylidene, and monomer including no fluorine atom, and silicone resins. These can be used alone or in combination. Of these, silicone resins are particularly preferable.

There is no specific limitation to the silicone resins and any known silicone resins are suitably selected to suit to a particular application.

Specific examples include, but are not limited to, straight silicone resins formed of only organosiloxane bond; and silicone resins modified by alkyd resins, polyester resins, epoxy resins, acrylic resins, and urethane resins.

The silicone resins can be procured.

Specific examples of the straight silicone resin include, but are not limited to, KR271, KR255, and KR152, manufactured by Shin-Etsu Chemical Co., Ltd.; and SR2400, SR2406, and SR2410, available from DOW CORNING TORAY CO., LTD.

The modified silicone resins are commercially available.

Specific examples include, but are not limited to, KR206 (alkyd-modified), KR5208 (acrylic-modified), ES1001N (epoxy-modified), and KR305 (urethane-modified) available from Shin-Etsu Chemical Co., Ltd.; and SR2115 (epoxy-modified), and SR2110 (alkyd-modified), available from DOW CORNING TORAY CO., LTD.

In this case, it is possible to use simple silicone resin, but it is also possible to use other components for cross-linking reactions or charge control simultaneously.

The resin layer may contain electroconductive powder such as metal powder, carbon black, titanium oxide, tin oxide, and zinc oxide. The average particle diameter of such electroconductive powder is preferably not greater than 1 μm. When the average particle diameter is greater than 1 μm, controlling the electric resistance may become difficult.

The resin layer described above can be formed by, for example, dissolving the silicone resin described above, etc. in a solvent to prepare a liquid application and applying the liquid application to the surface of the core material described above by a known application method followed by drying and baking.

Specific examples of the known application methods include, but are not limited to, a dip coating method, a spray coating method, and a brushing method.

There is no specific limitation to the solvent and it can be suitably selected to suit to a particular application.

Specific examples include, but are not limited to, toluene, xylene, methylethylketone, methylisobutyll ketone, cellosolve, and butylacetate.

There is no specific limitation to the baking. An external heating system or an internal heating system can be used. For example, a fixed electric furnace, a fluid electric furnace, a rotary electric furnace, a method of using a burner furnace, and a method of using a microwave can be suitably used.

The content of the carrier in the resin layer is preferably between 0.01 percent by mass and 5.0 percent by mass. When the content is less than 0.01 percent by mass, it is difficult in some cases to form a uniform layer on the surface of the core material. When the content is greater than 5.0 percent by mass, the resin layer may become excessively thick, thereby causing granulation between carrier particles so that uniform carrier particles are not obtained.

When the developing agent described above is a two component developing agent, there is no specific limitation to the content of the carrier in the two component developing agent. For example, the content is preferably from 90 to 98 percent by mass and more preferably from 93 to 97 percent by mass.

In general, the mixing ratio of the toner to the carrier in the two component developing agent is preferably from 1 to 10.0 parts by mass based on 100 parts by mass of the carrier.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present disclosure is described in detail with reference to Examples but are not limited thereto.

“Parts” represents parts by mass and “percent” represents percent by mass unless otherwise specified in the following description.

### Measurement of Glass Transition Temperature (Tg) of Resin and Melting Points of Crystalline Resin and Wax

The glass transition temperature Tg of the resin in Examples and Comparative Examples was measured with a differential scanning calorimetry (DSC) system, Q-200, available from TA Instruments.

A total of 5.0 mg of the resin sample was put into an aluminum sample pan, which was then held on a holder unit and placed in an electric furnace. A reference sample of alumina weighing 10 mg was used, and like the sample, it was placed in an aluminum sample pan.

Under a nitrogen atmosphere, the sample was heated from 0 to 150 degrees C. at a heating rate of 10 degrees C./min (first heating), then cooled from 150 to 0 degrees C. at a cooling rate of 10 degrees C./min (cooling process), and heated again from 0 to 150 degrees C. at a heating rate of 10 degrees C./min (second heating). The heat flux changes during these processes were measured, and a graph of temperature versus heat flux was plotted to obtain a DSC curve. The DSC curve obtained was analyzed using the analysis program in the Q-200 system.

The DSC curve for the second heating was selected, and the glass transition temperature of the resin sample was determined from the intersection of the baseline extension line of the DSC curve at temperatures lower than the enthalpy relaxation and the tangent indicating the maximum slope during enthalpy relaxation.

Similarly, the DSC curve for the second heating was selected, and the peak temperature of heat absorption was considered as the melting point of the crystalline resin or wax sample.

### Measurement of Weight Average Molecular Weight (Mw) of Resin

The weight average molecular weight (Mw) of the resin in Examples and Comparative Examples was measured by using a gel permeation chromatography (GPC) measuring device, HLC-8220 GPC, available from TOSOH CORPORATION. The column used was TSK gel Super HZM-M 15 cm triplet (available from TOSOH CORPORATION).

The resin to be measured was dissolved in tetrahydrofuran (THF) (containing stabilizers, available from Wako Pure Chemical Industries, Ltd.) to prepare a 0.15 percent by mass solution. After filtration through a 0.2 μm filter, the filtrate was used as the sample. A total of 100 μl of the THF sample solution was injected into the measuring instrument under the condition that the temperature was 40 degrees C. and the flow speed is 0.35 mL/min. The molecular weight was calculated by using a standard curve made by a mono-dispersed polystyrene standard sample. The polystyrene standard samples used were THF solutions of the following three types of monodisperse polystyrene standard samples from the Showdex STANDARD series, available from Showa Denko Co., Ltd. Measurements were conducted under the aforementioned conditions to create a calibration curve using the retention time of the peak top as the light-scattering molecular weight of the monodisperse polystyrene standard samples. The detector used was a refractive index (RI) detector.
Solution A: S-7300 2.5 mg, S-602 2.5 mg, S-46 2.5 mg, S-2.8 2.5 mg, THF 50 mL
Solution B: S-3500 2.5 mg, S-277 2.5 mg, S-18 2.5 mg, S-1.3 2.5 mg, THF 50 mL
Solution C: S-1700 2.5 mg, S-136 2.5 mg, S-6.7 2.5 mg, toluene 2.5 mg, THF 50 mL

### Measurement of Acid Value (AV) and Hydroxyl Value (OHV)

The acid value (AV) and hydroxyl value (OHV) of the resin in Examples and Comparative Examples were measured according to JIS K0070 (Test methods for acid value, saponification value, ester value, iodine value, hydroxyl value and unsaponifiable matter of chemical products). However, the measurement solvent for acid value was a mixed solvent of acetone, methanol, and toluene (acetone:methanol=12.5:12.5:75), and the measurement solvent for hydroxyl value was tetrahydrofuran (THF)

### Measurement of Volume Average Particle Diameter (Dv) of Rein Particle and Toner

The volume average particle diameter (Dv) of resin particles and toner in Examples and Comparative Examples was measured using a Coulter Multisizer III (aperture diameter 100 m, available from Beckman Coulter) and analysis software, Beckman Coulter Multisizer 3 (version 3.51, available from Beckman Coulter).

A measuring sample of 10 mg was added to 5 mL of a 10 percent by mass surfactant solution (alkylbenzenesulfonic acid salt, NeoGen SC-A, available from DKS Co., Ltd.) and dispersed for 1 minute using an ultrasonic disperser. Then 25 mL of electrolyte solution, Isoton III (available from Beckman Coulter), was added as desired, and dispersed for 1 minute to prepare a sample dispersion solution using an ultrasonic disperser. Subsequently, an appropriate amount of the electrolyte solution and the sample dispersion solution of 100 mL were added to a beaker, and 30,000 particles were measured at a concentration where the particle diameter of 30,000 particles was able to be measured in 20 seconds. The volume average particle diameter (Dv) was then determined from its particle size distribution.

### Manufacturing Example of Amorphous Polyester Resin (A)

### Production of Amorphous Polyester Resins (A-1) to (A-5)

To a reaction vessel equipped with a cooling pipe, a stirrer, and a nitrogen introduction pipe, the raw material of “raw material 1” shown in Table 1 were added, at a molar ratio (OH/COOH) of hydroxyl groups to carboxylic acids adjusted to 1.2. Additionally, a condensation catalyst, tetra-n-butoxy titanium, was added at 1,000 ppm to the entire of the monomer. The temperature was raised to 200 degrees C. over 2 hours under a nitrogen stream, then further raised to 230 degrees C. over 8 hours, followed by reaction for 5 hours during which water produced was removed. Subsequently, the reaction was carried out for 1 hour under a reduced pressure of 5 to 15 mmHg, then cooled to 200 degrees C. Anhydrous trimellitic acid was added in an amount shown in Table 1, and the reaction was carried out for 1 hour at 200 degrees C. under atmospheric pressure. The reaction was continued under reduced pressure of 5 to 20 mmHg until the desired molecular weight was reached, obtaining Polyester Resins (A-1) to (A-5) as Polyester Resins (A).

Amorphous Polyester Resins (A-1) to (A-5) obtained were subjected to measurements of glass transition temperature (Tg), weight average molecular weight, acid value (AV), and hydroxyl value (OHV). The results are shown in Table 1.

### Example 1-1

### Production of Polyester Resin Emulsion (EM-1)

A total of 150 parts by mass of Polyester Resin (A-1) and 150 parts by mass of methyl ethyl ketone were placed in a 500 mL separable flask equipped with a stirrer. Additionally, sodium hydroxide (0.3 N) was added at 75 percent equivalent to the acid value of Polyester Resin (A-1) to neutralize it, preparing a resin liquid mixture. Next, while the resin liquid mixture was stirred, 400 parts of deionized water was gradually added to conduct phase inversion emulsification. Then the resulting substance was subjected to solvent removal under reduced pressure using an evaporator. Deionized water was added to achieve a solid content concentration of 25 percent by mass, obtaining Polyester Resin Emulsion (EM-1).

### Example 1-2

### Production of Polyester Resin Emulsion (EM-2)

A total of 150 parts by mass of Polyester Resin (A-1) and 150 parts by mass of methyl ethyl ketone were placed in a 500 mL separable flask equipped with a stirrer. Additionally, sodium hydroxide (0.3 N) was added at 120 percent equivalent to the acid value of Polyester Resin (A-1) to neutralize it, preparing a resin liquid mixture. Next, while the resin liquid mixture was stirred, 400 parts of deionized water was gradually added to conduct phase inversion emulsification. Then the resulting substance was subjected to solvent removal under reduced pressure using an evaporator. Deionized water was added to achieve a solid content concentration of 25 percent by mass, obtaining Polyester Resin Emulsion (EM-2).

### Examples 1-3 to 1-6

### Production of Polyester Resin Emulsions (EM-3) to (EM-6)

Polyester Resin Emulsions (EM-3) to (EM-6) were obtained in the same manner as in Example 1 except that Polyester Resin (A-2) to (A-5) were used instead of Polyester Resin (A-1).

### Example 1-7

### Production of Polyester Resin Emulsion (EM-7)

A total of 3 g pf 1 percent aqueous solution of sodium hydroxide was added dropwise to Polyester Resin Emulsion (EM-4) to obtain Polyester Resin Emulsion (EM-7).

### Comparative Example 1-1

### Production of Polyester Resin Emulsion (EM-8)

A total of 150 parts by mass of Polyester Resin (A-1) and 150 parts by mass of methyl ethyl ketone were placed in a 500 mL separable flask equipped with a stirrer. Additionally, sodium hydroxide (0.3 N) was added at 40 percent equivalent to the acid value of Polyester Resin (A-1) to neutralize it, preparing a resin liquid mixture. Next, while the resin liquid mixture was stirred, 400 parts of deionized water was gradually added to conduct phase inversion emulsification. Then the resulting substance was subjected to solvent removal under reduced pressure using an evaporator. Deionized water was added to achieve a solid content concentration of 25 percent by mass, obtaining Polyester Resin Emulsion (EM-8).

### Comparative Examples 1-2

### Production of Polyester Resin Emulsion (EM-9)

A total of 150 parts by mass of Polyester Resin (A-1) and 150 parts by mass of methyl ethyl ketone were placed in a 500 mL separable flask equipped with a stirrer. Additionally, sodium hydroxide (0.3 N) was added at 130 percent equivalent to the acid value of Polyester Resin (A-1) to neutralize it, preparing a resin liquid mixture. Next, while the resin liquid mixture was stirred, 400 parts of deionized water was gradually added to conduct phase inversion emulsification. Then the resulting substance was subjected to solvent removal under reduced pressure using an evaporator. Deionized water was added to achieve a solid content concentration of 25 percent by mass, obtaining Polyester Resin Emulsion (EM-9).

### Comparative Examples 1-3

### Production of Polyester Resin Emulsion (EM-10)

A total of 150 parts by mass of Polyester Resin (A-3) and 150 parts by mass of methyl ethyl ketone were placed in a 500 mL separable flask equipped with a stirrer. Additionally, sodium hydroxide (0.3 N) was added at 40 percent equivalent to the acid value of Polyester Resin (A-1) to neutralize it, preparing a resin liquid mixture. Next, while the resin liquid mixture was stirred, 400 parts of deionized water was gradually added to conduct phase inversion emulsification. Then the resulting substance was subjected to solvent removal under reduced pressure using an evaporator. Deionized water was added to achieve a solid content concentration of 25 percent by mass, obtaining Polyester Resin Emulsion (EM-10).

The median diameter (D50) of Polyester Resin Emulsions (EM-1) to (EM-10) obtained as mentioned above were measured, and the measurements were shown in Table 2, along with neutralization ratio (equivalent by percent), B/A value, and pH.

The degree of aggregation of the aggregated salts of shell particles in Polyester Resin Emulsions (EM-1) to (EM-10) was evaluated.

### Evaluation on Degree of Aggregation of Aggregation Salts of Shell Particles

A 10 g sample of Polyester Resin Emulsions (EM-1) to (EM-10) adjusted to a solid content concentration of 10 percent with deionized water was placed in a container and stirred with a magnetic stirrer. During stirring, a 5 percent calcium chloride solution was added dropwise until the volume-weighted average particle diameter of the sample solution became twice or more of the diameter before the addition of calcium chloride. The minimum concentration of calcium chloride in the sample solution at this point was defined as the critical aggregation concentration. The volume average particle diameter was measured with a nano track particle size distribution measuring device (UPA-EX150, available from Nikkiso Co., Ltd.) based on a dynamic light scattering method or a laser Doppler method.

The percent value in the evaluation criteria below is the critical aggregation concentration.

### Evaluation Criteria

A: 7 percent to less than 12 percent
B: 5 percent to less than 7 percent, or 12 percent to less than 14 percent
C: less than 5 percent or 14 percent or higher

Next, Manufacturing Examples of manufacturing resin particles (T) and toners (T) using Polyester Resin Emulsions (EM-1) to (EM-10) obtained are described.

### Manufacturing Examples of Amorphous Polyester Resin (B)

To a reaction vessel equipped with a cooling pipe, a stirrer, and a nitrogen introduction pipe, acid monomers and alcohol monomers shown in Table 1 were added, at a molar ratio (OH/COOH) of hydroxyl groups to carboxylic acids adjusted to 1.2. Additionally, a condensation catalyst, tetra-n-butoxy titanium, was added at 1,000 ppm to the entire of the monomer. The temperature was raised to 200 degrees C. over 2 hours under a nitrogen stream, then further raised to 230 degrees C. over 8 hours, followed by reaction for 5 hours during which water produced was removed. Subsequently, the reaction was carried out for 1 hour under a reduced pressure of 5 to 15 mmHg, then cooled to 200 degrees C. Anhydrous trimellitic acid was added in an amount shown in Table 1, and the reaction was carried out for 1 hour at 200 degrees C. under atmospheric pressure. The reaction was continued under reduced pressure of 5 to 20 mmHg until the desired molecular weight was reached, obtaining Amorphous Polyester Resin (B).

Amorphous Polyester Resin (B) obtained was subjected to measurements of glass transition temperature (Tg), weight average molecular weight, acid value (AV), and hydroxyl value (OHV). The results are shown in Table 1.

### Manufacturing Example of Crystalline Polyester Resin (C)

To a reaction vessel equipped with a cooling pipe, a stirrer, and a nitrogen introduction pipe, 1,6-hexanediol and sebacic acid as the dicarboxylic acid component were introduced to achieve a molar ratio (OH/COOH) of hydroxyl groups to carboxylic acids at 1.1. Additionally, as a condensation catalyst, titanium dihydroxy bis(triethanolaminate) was added at 500 ppm relative to the entire of the monomer. The temperature was raised to 180 degrees C. over 2 hours under a nitrogen stream, and the generated water was removed while the reaction proceeded for 8 hours. Subsequently, the temperature was gradually raised to 220 degrees C. while removing the generated water under a nitrogen stream, and the reaction was allowed to proceed for 5 hours. Under a reduced pressure of 5 to 20 mmHg, Crystalline Polyester Resin (C) with a melting point of 68 degrees C., an acid value of 10.5 mg KOH/g, and a weight average molecular weight of 11,000 was obtained.

### Manufacturing Example of Liquid Dispersion (D) of Crystalline Polyester Resin

In a reaction vessel equipped with a cooling pipe, a thermometer, and a stirrer, 10 parts by mass of Crystalline Polyester Resin (C) and 90 parts by mass of ethyl acetate were placed and heated to 77 degrees C. until fully dissolved. The mixture was then cooled to 30 degrees C. over 1 hour with stirring. Subsequently, wet grinding was conducted using an Ultra Bead Mill (available from Aimex Corporation) under the following conditions: a liquid feed rate of 1.0 kg/hr, a disc peripheral speed of 10 m/second, 80 percent by volume of 0.5 mm zirconia beads, and 6 passes. Ethyl acetate was then added to adjust the solid content to 10 percent, resulting in Liquid Dispersion (D) of Crystalline Polyester Resin with a median particle diameter (D50) of 0.3 μm, as measured by a laser particle size distribution analyzer LA-920 (available from HORIBA, Ltd.).

### Manufacturing Example of Colorant Master Batch

### Manufacturing of Colorant Master Batch (MB)

A total of 100 parts of Amorphous Polyester Resin (B), 100 percent by mass of cyan pigment (Pigment Blue 15:3), and 50 parts by mass of deionized water were thoroughly mixed, and the mixture was kneaded using an open roll type kneading machine (Kneadex, available from NIPPON COKE & ENGINEERING CO., LTD.). The kneading temperature was maintained at 80 degrees C., then raised to 120 degrees C. to remove water, obtaining Colorant Master Batch (MB) with a resin-to-pigment ratio (mass ratio) at 1:1.

### Manufacturing Example of Liquid Dispersion of Wax

### Manufacturing of Liquid Dispersion (W) of Wax

In a reaction vessel equipped with a cooling pipe, a thermometer, and a stirrer, 20 parts by mass of ester wax (WE-11, melting point of 70 degrees C., available from NOF CORPORATION) and 80 parts by mass of ethyl acetate (available from FujiFilm Wako Pure Chemical Corporation) were placed and heated to 77 degrees C. until fully dissolved. The mixture was then cooled to 30 degrees C. over 1 hour with stirring. Subsequently, wet grinding was conducted using an Ultra Bead Mill (available from Aimex Corporation) under the following conditions: a liquid feed rate of 1.0 kg/hr, a disc peripheral speed of 10 m/second, 80 percent by volume of 0.5 mm zirconia beads, and 6 passes. Ethyl acetate was then added to adjust the solid content to 20 percent, resulting in Liquid Dispersion (W) of Wax with a median particle diameter (D50) of 0.6 μm, as measured by a laser particle size distribution analyzer LA-920 (available from HORIBA, Ltd.).

### Manufacturing Example of Liquid Dispersion of Core Particle

### Production of Liquid Dispersion (CR) of Core Particle by Suspension Emulsion Method

In a container equipped with a stirrer and a thermometer, 68 parts by mass of deionized water, 1 part by mass of sodium carboxymethyl cellulose, 16 parts by mass of a 48 percent aqueous solution of sodium dodecyl diphenyl ether disulfonate (Eleminol MON-7, available from Sanyo Chemical Industries, Ltd.), and 5 parts by mass of ethyl acetate were mixed and stirred. Subsequently, 10 parts by mass of an emulsion for particle size control containing a copolymer of styrene-methacrylic acid-butyl acrylate-ethylene oxide adduct sulfonic ester sodium salt (solid content concentration: 20 percent, median diameter: 50 nm, available from Sanyo Chemical Industries, Ltd.) were added to prepare Aqueous Phase Liquid.

Next, in another container equipped with a stirrer and a thermometer, 76 parts by mass of Amorphous Polyester Resin (B), 60 parts by mass of Liquid Dispersion (D) of Crystalline Polyester Resin, 30 parts by mass of Liquid Dispersion (W) of Wax, and 12 parts by mass of Colorant Master Batch (MB) were added. Ethyl acetate was then added to adjust the solid content concentration to 50 percent, and the mixture was stirred until completely dissolved. Using a TK homomixer (available from Tokushu Kikai Co., Ltd.), the mixture was then dispersed at a rotation speed of 8,000 rpm for 2 hours to achieve uniform dissolution and suspension, thereby preparing the Oil Phase.

A total of 50 parts by mass of Oil Phase was added to a container containing Aqueous Phase Liquid to obtain emulsification slurry by mixing for 1 minute at a rotation speed of 12,000 rpm using a TK homomixer (available from Tokushu Kikai Co., Ltd.) at a liquid temperature of 30 to 40 degrees C.

The obtained emulsified slurry was transferred to another container equipped with a stirrer, a nitrogen introduction tube, and a thermometer, and during stirring, it was heated to 50 degrees C. to remove ethyl acetate under a nitrogen atmosphere. A ten percent aqueous solution of sodium hydroxide (available from Fuji Film Wako Pure Chemical Corporation) was added to adjust the pH of the emulsified slurry to 12. Thereafter, it was heated at 45 degrees C. for 10 hours, dissolving and removing the emulsion for particle size control adhering to the particle surface in the emulsified slurry, followed by suction filtration to obtain solid content.

The solid content obtained was subjected to a washing process of reslurrying with deionized water equivalent to 40 times the mass of the solid content, followed by filtering after through stirring. This washing process was repeated once more, and deionized water was added again to adjust the solid content concentration to 25 percent by mass, thereby obtaining Liquid Dispersion (CR) of Core Particle.

### Manufacturing Example of Carrier

The following materials were dispersed using a stirrer for 10 minutes to prepare a coating liquid:
5,000 parts by mass of Mn ferrite particles (weight average diameter: 35 μm) as the core material 300 parts by mass of toluene as the coating material
300 parts by mass of butyl cellosolve
60 parts by mass of an acrylic resin solution (composition ratio: methacrylic acid:methyl methacrylate:2-hydroxyethyl acrylate=5:9:3, 50 percent solid content in toluene, Tg 38 degrees C.)
parts by mass of an N-tetramethoxymethylbenzoguanamine resin solution (polymerization degree 1.5, 77 percent solid content in toluene)
parts by mass of alumina particles (average primary particle diameter: 0.30 μm)

These materials were then fed into a coating device equipped with a rotary bottom plate disc and stirring blades to form a swirling flow in a fluidized bed, where the coating liquid was applied onto the core material. The resulting coated material was baked in an electric furnace at 220 degrees C. for 2 hours to obtain Carrier.

### Example 2-1

### Manufacturing of Resin Particles (T) or Toner (TN)

A total of 320 parts by mass of Liquid Dispersion of Core Particle (solid content concentration of 25 percent by mass) was added to a container equipped with a stirrer and a thermometer. Then a 20 percent by mass magnesium sulfate aqueous solution was added dropwise at a rate of 2 parts by mass per minute during stirring until the magnesium sulfate reached 1 percent by mass of the entire solid content. The temperature was then raised to 55 degrees Celsius, and stirring was continued for 30 minutes. Subsequently, 80 parts of Polyester Resin Emulsion (EM-1) (solid content concentration of 25 percent) were added, and the mixture was stirred for 30 minutes. Then 100 parts of a 10 percent sodium chloride aqueous solution were added, and the temperature was raised to 70 degrees Celsius. Stirring was continued until the average circularity reached 0.970. Subsequently, the container was moved to an ice bath for cooling to room temperature, followed by suction filtration to obtain solid contents. To the obtained solids, 800 parts by mass of deionized water were added, stirred to re-slurry, and then subjected to suction filtration to obtain solids. This process was repeated five times, followed by drying at 45 degrees C. for 48 hours in a fluidized bed dryer.

The resulting dried matter was sieved with a 75 μm mesh to obtain Resin Particles (T), referred to as Resin Particles (T-1).

A total of 1.0 part by mass of hydrophobic silica (HDK-2000, available from Wacker Chemie AG) and 0.3 parts by mass of titanium oxide (MT-150AI, available from TAYCA CORPORATION) were added to 100 parts by mass of Resin Particles (T-1) obtained, and mixed using a Henschel mixer. The mixture was then sieved with a 25 μm mesh to obtain Toner (TN-1).

### Manufacturing of Developing Agent

Developing Agent D-1, which was a two-component developing agent, was obtained by uniformly mixing 7 parts by mass of Toner TN-1 with 100 parts by mass of Carrier using a type of tumbler mixer (available from Willy A. Bachofen (WAB) GmbH) that rotated the container at 48 rpm for 5 minutes.

The toner was evaluated on mechanical durability using this Developing Agent D-1.

The evaluation results are shown in Table 3.

### Evaluation on Mechanical Durability of Toner

Developing Agent D-1 was loaded into the developing unit of the digital color multifunction printer RICOH IM C5500 (available from Ricoh Co., Ltd.), and after printing 30,000 sheets in monochrome mode, the developing agent was extracted. An appropriate amount of the developing agent extracted was then placed in a gauge with a mesh opening of 32 μm, followed by air blowing to separate the toner from the carrier. Subsequently, the carrier ClientRef. No. FN202400435 (10 g) obtained was placed in a 50 ml glass bottle, and 10 ml of methyl ethyl ketone was added. The mixture was hand-shaken 50 times and left to rest for 10 minutes. Afterward, the supernatant methyl ethyl ketone solution was loaded in a glass cell, and the transmittance of the methyl ethyl ketone solution was measured using a turbidity meter.

### Evaluation Criteria

S (extremely excellent): Transmittance of 95 percent or higher (extremely excellent)
A: (excellent) Transmittance of 90 to less than 95 percent
B: (fair as compared with typical product) Transmittance of 80 to less than 90 percent
C: (poor) Transmittance of less than 80 percent

### Examples 2-2 to 2-7, Comparative Examples 2-1 to 2-3

Resin Particle (T-2) to (T-10) were obtained in the same manner as in Example 2-1 except that Polyester Resin Emulsions (EM-2) to (EM-10) were used instead of Polyester Resin Emulsion (EM-1).

Then Toner (TN-2) to (TN-10) and Developing Agent (D-2) to (D-10) were obtained in the same manner as in Example 2-1 except that Resin Particle (T-2) to (T-10) were used instead of Resin Particle (T-1).

Developing Agent (D-2) to (D-10) were similarly evaluated as in Example 2-1.

The evaluation results are shown in Table 3.

TABLE 1

| | | | | | | | | Amorphous |
|---|---|---|---|---|---|---|---|---|
| | | | | | | | | polyester |
| | | | Amorphous Polyester Resin (A) | | | | | resin (B) |
| | | | A-1 | A-2 | A-3 | A-4 | A-5 | — |
| Raw | Acid | Adipic acid | | | | 14.6 | | 14.6 |
| material 1 | | Isophthalic | 15.0 | 74.8 | 83.1 | 66.5 | 77.3 | 66.5 |
| | | acid | | | | | | |
| | | Terephthalic | | | | | | |
| | | acid | | | | | | |
| | | Succinic acid | 7.1 | 5.9 | | | | |
| | Alcohol | Adduct of | 15.6 | 70.3 | 125.1 | 126.6 | 125.8 | 126.6 |
| | | 2 moles | | | | | | |
| | | Adduct of | 0.0 | 25.5 | 68.1 | 68.9 | 68.2 | 68.9 |
| | | 2 moles | | | | | | |
| | | 1,2-propane | 15.0 | 22.6 | | | | |
| | | diol | | | | | | |
| | | 1,3-propane | | | | | | |
| | | diol | | | | | | |
| | | 1,4-butane | | | | | | |
| | | diol | | | | | | |
| | | 2,3-butane | | | | | | |
| | | diol | | | | | | |
| | | Trimethylol | 0.8 | 0.8 | 0.8 | | | |
| | | propane | | | | | | |
| | | 1,2,3-butane | | | | | | |
| | | triol | | | | | | |
| | | 1,2,4,5- | | | | | | |
| | | hexane tetraol | | | | | | |
| | | 1,2,3,4- | | | | | | |
| | | butane tetraol | | | | | | |
| | | Pentaerythritol | | | | | | |
| | | Glycerol | | | | | | |
| | | Sorbitol | | | | | | |
| | Polyethylene | | 67.1 | | | | | |
| | terephthalate | | | | | | | |
| | (PET) | | | | | | | |
| Raw | Anhydrous trimellitic acid | | 4.8 | 4.8 | 4.8 | 4.8 | 2.5 | 4.8 |
| material 2 | | | | | | | | |

| Ratio (mole percent) in alcohol component* | | 33.0 | 49.5 | 0.0 | 0.0 | 49.7 | 0.0 |
|---|---|---|---|---|---|---|---|
| Resin | Tg (g) | 61.5 | 57.2 | 55.8 | 52.1 | 56.9 | 52.1 |
| properties | Mw (—) | 16,000 | 11,000 | 15,000 | 12,000 | 12,000 | 12,000 |
| | Av (mgKOH/g) | 19.1 | 20.8 | 20.1 | 25.3 | 13.9 | 25.3 |
| | OHV (mgKOH/g) | 8.4 | 8.7 | 8.4 | 12.3 | 7.8 | 12.3 |

*unit of the values in Table is parts by mass

TABLE 2

| | Example | | | | | | | Comparative Example | | |
|---|---|---|---|---|---|---|---|---|---|---|
| | 1-1 | 1-2 | 1-3 | 1-4 | 1-5 | 1-6 | 1-7 | 1-1 | 1-2 | 1-3 |
| Polyester | EM-1 | EM-2 | EM-3 | EM-4 | EM-5 | EM-6 | EM-7 | EM-8 | EM-9 | EM-10 |
| resin | | | | | | | | | | |
| emulsion | | | | | | | | | | |
| Amorphous | A-1 | A-1 | A-2 | A-3 | A-4 | A-5 | A-3 | A-1 | A-1 | A-3 |
| polyester | | | | | | | | | | |
| resin (A) | | | | | | | | | | |
| Acid value | 19.1 | 19.1 | 20.8 | 20.1 | 25.3 | 13.9 | 20.1 | 19.1 | 19.1 | 20.1 |
| (mgKOH/g): | | | | | | | | | | |
| Neutralization | 75 | 120 | 50 | 100 | 75 | 120 | 100 | 40 | 130 | 40 |
| ratio | | | | | | | | | | |
| (equivalent | | | | | | | | | | |
| by percent) | | | | | | | | | | |
| B | 25.5 | 40.8 | 18.5 | 35.8 | 33.8 | 29.7 | 35.8 | 13.6 | 44.3 | 14.3 |
| B/A | 1.34 | 2.14 | 0.89 | 1.78 | 1.34 | 2.14 | 1.78 | 0.71 | 2.32 | 0.71 |
| pH of | 7.0 | 8.0 | 5.6 | 7.3 | 6.3 | 8.3 | 8.4 | 6.2 | 8.1 | 5.6 |
| emulsion | | | | | | | | | | |
| Degree of | A | A | A | A | B | B | B | C | C | C |
| aggregation | | | | | | | | | | |
| Median | 0.025 | 0.014 | 0.022 | 0.021 | 0.034 | 0.026 | 0.021 | 0.30 | 0.105 | 0.28 |
| diameter | | | | | | | | | | |
| (D50) (μm) | | | | | | | | | | |

TABLE 3

| | | | | | | | | | Comparative | | |
|---|---|---|---|---|---|---|---|---|---|---|---|
| | | Example | | | | | | | Example | | |
| | | 2-1 | 2-2 | 2-3 | 2-4 | 2-5 | 2-6 | 2-7 | 2-1 | 2-2 | 2-3 |
| Resin particle (T) | | T-1 | T-2 | T-3 | T-4 | T-5 | T-6 | T-7 | T-8 | T-9 | T-10 |
| Toner | | TN-1 | TN-2 | TN-3 | TN-4 | TN-5 | TN-6 | TN-7 | TN-8 | TN-9 | TN-10 |
| Developing agent | | D-1 | D-2 | D-3 | D-4 | D-5 | D-6 | D-7 | D-8 | D-9 | D-10 |
| Configuration | Core | CR | | | | | | | | | |
| | particle | | | | | | | | | | |
| | Shell | EM-1 | EM-2 | EM-3 | EM-4 | EM-5 | EM-6 | EM-7 | EM-8 | EM-9 | EM-10 |
| | Particle | | | | | | | | | | |

| | | | | | | | | | | |
|---|---|---|---|---|---|---|---|---|---|---|
| Mechanical durability | S | S | A | A | A | A | A | B | B | C |
| of toner | | | | | | | | | | |
| Comprehensive | S | S | A | A | A | A | A | C | C | C |
| judgment | | | | | | | | | | |

Aspects of the present disclosure are, for example, as follows:

Aspect 1 A polyester resin emulsion contains resin particles (S) containing an amorphous polyester resin (A) in which the carboxyl group of a polyester resin obtained by polycondensation of the alcohol component and the carboxylic acid component is neutralized by a basic substance and an aqueous medium where the resin particles (S) are dispersed, wherein the following relationship 1 is satisfied:

$$0.89 \leq B / A \leq 2.23 ,$$

where A represents an acid value of the amorphous polyester resin (A) and B represents an amount in mmol/g of cation derived from the basic substance.

### Aspect 2

The polyester resin emulsion according to Aspect 1 mentioned above, wherein the acid value of the amorphous polyester resin (A) is between 15 mgKOH/g and 30 mgKOH/g.

### Aspect 3

The polyester resin emulsion according to Aspect 1 or 2 mentioned above, having a pH between 5.5 and 8.0.

### Aspect 4

The polyester resin emulsion according to any one of Aspects 1 to 3 mentioned above, wherein the alcohol component comprises trivalent or tetravalent alcohol with a linear or branched saturated aliphatic backbone with 4 to 6 carbon atoms.

### Aspect 5

The polyester resin emulsion according to any one of Aspects 1 to 4 mentioned above, wherein the alcohol component comprises at least one member selected from the group consisting of 1,2-propane diol, 1,3-propanediol, 1,4-butanediol, and 2,3-butanediol, the at least one member accounting for 30 mole percent of an entire of the alcohol component.

### Aspect 6

The polyester resin emulsion according to any one of Aspects 1 to 5 mentioned above, wherein the amorphous polyester resin (A) comprises a repeating unit derived from polyethylene terephthalate comprising a condensate of terephthalic acid and ethylene glycol.

### Aspect 7

A resin particle contains a resin particle (T) with a core-shell structure containing a shell layer formed from the polyester resin emulsion of any one of Aspects 1 to 6 mentioned above.

### Aspect 8

A toner contains a core particle and a shell layer on the surface of the core particle, wherein the shell layer is formed of the polyester resin emulsion of any one of Aspects 1 to 6 mentioned above.

### Aspect 9

The toner according to Aspect 8 mentioned above, wherein the core particle contains an amorphous polyester resin (B).

Aspect 10. A method of manufacturing a toner with a core-shell structure includes forming a shell layer from the polyester resin emulsion of any one of Aspects 1 to 6 mentioned above and forming the shell layer on a core particle.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A polyester resin emulsion, comprising:
resin particles (S) comprising an amorphous polyester resin (A) in which a carboxyl group of a polyester resin obtained by polycondensation of an alcohol component and a carboxylic acid component is neutralized by a basic substance; and
an aqueous medium where the resin particles (S) are dispersed,
wherein the following relationship 1 is satisfied:
$$0.89 \leq B / A \leq 2.23 ,$$
where A represents an acid value of the amorphous polyester resin (A) and B represents an amount in mmol/g of cation derived from the basic substance.

2. The polyester resin emulsion according to claim 1, wherein the acid value of the amorphous polyester resin (A) is between 15 mgKOH/g and 30 mgKOH/g.

3. The polyester resin emulsion according to claim 1, having a pH between 5.5 and 8.0.

4. The polyester resin emulsion according to claim 1,
wherein the alcohol component comprises trivalent or tetravalent alcohol with a linear or branched saturated aliphatic backbone with 4 to 6 carbon atoms.

5. The polyester resin emulsion according to claim 1,
wherein the alcohol component comprises at least one member selected from the group consisting of 1,2-propane diol, 1,3-propanediol, 1,4-butanediol, and 2,3-butanediol, the at least one member accounting for 30 mole percent of an entire of the alcohol component.

6. The polyester resin emulsion according to claim 1,
wherein the amorphous polyester resin (A) comprises a repeating unit derived from polyethylene terephthalate comprising a condensate of terephthalic acid and ethylene glycol.

7. A resin particle comprising:
a resin particle (T) with a core-shell structure comprising a shell layer formed from the polyester resin emulsion of claim 1.

8. A toner comprising:
a core particle; and
a shell layer on a surface of the core particle,
wherein the shell layer is formed of the polyester resin emulsion of claim 1.

9. The toner according to claim 8, wherein the core particle comprises an amorphous polyester resin (B).

10. A method of manufacturing a toner with a core-shell structure, comprising:
forming a shell layer from the polyester resin emulsion of claim 1; and
forming the shell layer on a core particle.
